(19) United States
(12) Patent Application Publication
(10) Pub. No.: US 2025/0065929 A1
(43) Pub. Date: Feb. 27, 2025

(54) Manway Cleaning Guard

(71) Applicant: David Ewen, Yuba City, CA (US)

(72) Inventor: David Ewen, Yuba City, CA (US)

(21) Appl. No.: 18/455,882

(22) Filed: Aug. 25, 2023

(51) Int. Cl. B61D 7/16

(52) U.S. Cl. CPC B61D 7/16

(57) ABSTRACT

A safety device for tank manways, which is easily installed and removed, to protect personnel from hazardous spray from cleaning chemicals used when the tank is being cleaned. The device deflects and blocks the spray, allowing it to safely flow out the bottom of the manway.

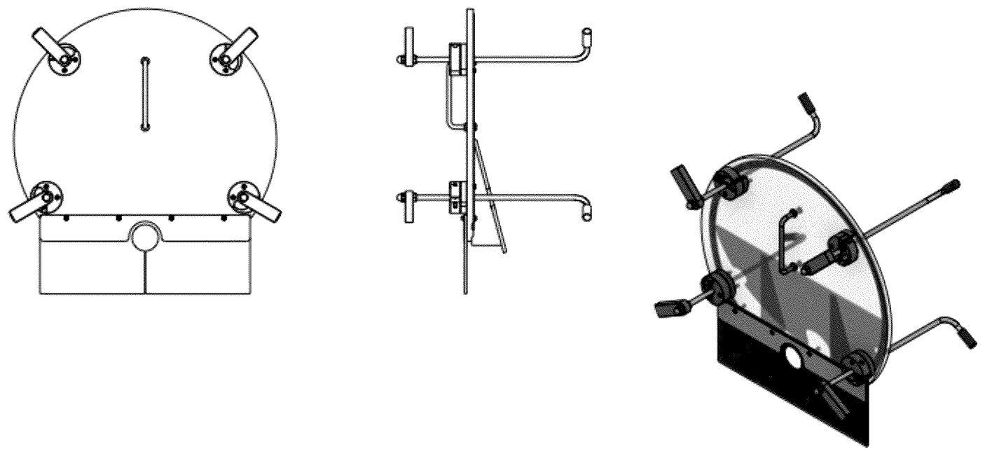

### BACKGROUND

The “Manway Cleaning Guard” (also referred to as “MCG”) was designed to keep cleaning personnel safe from chemical and hot water spray during the tank cleaning process. It was designed for wineries, but can be used for any vessel that does not have a permanently mounted cleaning system. It covers the open manway of a tank to keep water & chemicals from spraying out during the cleaning process while still allowing the tank to drain when required.

### SUMMARY

To use the MCG, place it against the manway opening after the tank cleaner has been inserted into the tank. Pull and tighten each securing arm with the quick release clamps to hold the MCG in place. When cleaning process is finished, release the clamps, remove and set the MCG aside.

### DESCRIPTION OF THE DRAWINGS

Page 1 of drawing shows the overview of the assembled MCG.

Page 2 shows the acrylic body comprised of several pieces cemented together.

Page 3 shows the assembled quick release clamp.

Page 4 shows an exploded view of the quick release clamp.

### DETAILED DESCRIPTION

The assembly is constructed of various components which are bolted onto the main body with machine screws. The main body is made of clear acrylic which is cut out to match the size of a specified tank manway and cemented together with an solid spray deflector into one piece. (A common round style shown in the drawing, but different tanks often have different manway shapes and sizes.) Various features are cut/machined for attaching the handle, arms, clamps, and EPDM rubber spray deflector. A rubber gasket is glued around the perimeter.

The MCG utilizes quick release clamps to attach to the tank. The clamps use a cam action to clamp around the securing arms, but allow free rotation and movement when loose. These are made from Nylon plastic, but can be any chemical resistant plastic.

The arms are made from stainless steel for strength and corrosion resistance. All hardware and non plastic parts are also stainless steel.

The rubber deflector and acrylic deflector work together to be able to place the MCG over a hose going into the tank, keeping spray inside the tank while allowing flow to drain out of the tank.

The invention claimed is:

1. A safety device comprising: a main body that fits onto an existing tank manway in place of the original door; securing arms attached via quick release clamps to said main body; a solid spray deflector attached to inside of said main body, and a rubber spray deflector attached to the bottom of said main body.

2. A safety device as in claim 1, wherein said securing arms are adjustable in depth and rotation, and can be locked in place with said quick release clamps.

3. A safety device as in claim 1, wherein said body and deflectors allow for a hose to pass through into the tank, while still blocking the path of spray inside tank.
